(19) United States
(12) Patent Application Publication
(10) Pub. No.: US 2015/0330606 A1
(43) Pub. Date: Nov. 19, 2015

(54) DISPLAY DEVICE WITH MULTIPLE DISPLAY SURFACES

(71) Applicants: BOE TECHNOLOGY GROUP CO., LTD., Beijing (CN); BEIJING BOE DISPLAY TECHNOLOGY CO., LTD., Beijing (CN)

(72) Inventors: Hongyu ZHAO, Beijing (CN); Liang ZHANG, Beijing (CN); Inho Park, Beijing (CN); Xin LI, Beijing (CN); Yuanfu BAO, Beijing (CN); Xianyang FU, Beijing (CN)

(21) Appl. No.: 14/550,188

(22) Filed: Nov. 21, 2014

(30) Foreign Application Priority Data
May 14, 2014 (CN) 201410203669.0

(51) Int. Cl. F21V 13/08; F21V 9/14; F21V 7/04

(52) U.S. Cl. CPC F21V 13/08; F21V 7/04; F21V 9/14

(57) ABSTRACT

The present invention discloses a display device with multiple display surfaces, including: a multi-surface display structure including at least two display panels; a light source provided under the middle part of the display structure; and a reflective surface including at least two reflectors having inclination angles is arranged on the top of the multi-surface display structure. The light source is provided under the multi-surface display structure, such that the bottom space of the display device is efficiently utilized, and the light shadow is eliminated. Therefore, the display performance is improved. The curved reflective surface provided on the top of the multi-surface display structure can reflect the light emitted from the light source, such that the light emergent from each display panel is uniform. The light energy is efficiently utilized (i.e., the utilization of the light source is increased). Thus, the purpose of energy-saving is achieved.

### FIELD OF THE INVENTION

The present invention relates to the field of display technology, and in particularly relates to a display device with multiple display surfaces.

### BACKGROUND OF THE INVENTION

At present, a display device is usually used to provide information for the viewers in a public place. However, a display device with single display surface may not meet the requirement that the screen can be observed by viewers all around the device. Thus, a display device with multiple display surfaces is desired.

A conventional display device with multiple display surfaces is implemented by a plurality of independent display structures, and the effect of multi-surface display is realized by rear-connecting a plurality of backlights which are used for each corresponding display structure as a light source or placing light sources between the display structures. However, each display device and each backlight is installed independently, and color differences exist between various display devices during the displaying due to the difference between various backlights. Therefore, the viewing experience is affected. Moreover, the cost of rear-connecting backlights is high. When the light sources are placed between the plurality of display structures, the light sources are directly placed behind the display panels. Thus, a light shadow will be generated, which is hard to be eliminated. Therefore, the uniformity of display is affected.

As discussed above, the conventional display device with multiple display surfaces has light shadow during displaying. Therefore, the display performance is affected.

### SUMMARY OF THE INVENTION

1. Technical Problem:

The technical problem of the present invention is how to increase the uniformity of display and improve display performance.

2. Technical Solution:

In order to solve the above-mentioned technical problem, the present invention provides a display device with multiple display surfaces, including: a multi-surface display structure including at least two display panels; a light source which is provided under the middle part of the display structure; and a curved reflective surface including at least two reflectors having inclination angles is arranged on the top of the multi-surface display structure. The curved reflective surface is used to reflect the light emitted from the light source to the display surface of each display panel.

Further, the inclination angles of the reflectors are adjusted based on the number of the display panels and the positional relationship between the light source and the display panels.

Further, the display device with multiple display surfaces also includes an optical film and a diffusion plate stacked in sequence under each display panel. The display panels are disposed at the outer sides of the display device with multiple display surfaces and the diffusion plates are disposed at the innermost sides of the display device with multiple display surfaces.

Further, the transmittance of the diffusion plate is adjusted according to the light intensity distribution of the light source, the transmittance of a part of the diffusion plate corresponding to strong light intensity is small, and the transmittance of a part of diffusion plate corresponding to weak light intensity is large.

Further, the diffusion plate is a printing diffusion plate with reflective ink on its surface.

Further, each display panel includes an upper polarizer and a lower polarizer, a supplementary polarizer is provided between the lower polarizer and the optical film, and the transmitting axis of the supplementary polarizer is the same as that of the lower polarizer.

Further, the supplementary polarizer is a reflective polarizer.

Further, a fixing structure is used for connecting and fixing the display panels.

Further, the fixing structure is made of a metal material or a plastic material.

3. The Beneficial Effects:

The present embodiment of the present invention provides a display device with multiple display surfaces, including: a multi-surfaces display structure including at least two display panels; a light source which is provided under the middle part of the display structure; a curved reflective surface including at least two reflectors having inclination angles is provided on the top of the multi-surface display structure. The light source is provided under the multi-surfaces display structure, such that the bottom space of the display device is efficiently utilized, and the light shadow is eliminated. Therefore, the display performance is improved. The light emitted from the light source can be reflected by the curved reflective surface which is provided on the top of the multi-surface display structure, such that the light emergent from each display panels is uniform. Furthermore, the light energy is efficiently utilized, the utilization of the light source is improved, and the purpose of energy saving is achieved.

### BRIEF DESCRIPTION OF THE DRAWINGS

FIG. 1 is a schematic diagram showing a structure of a display device with multiple display surfaces according to an embodiment of the present invention.

FIG. 2 is a schematic diagram showing a positional relationship between a display panel and a polarizer, an optical film and a diffusion plate according to an embodiment of the present invention.

FIG. 3 is a schematic diagram showing connecting and fixing display panels by a fixing structure according to an embodiment of the present invention.

FIG. 4 is a schematic diagram showing a structure of a display device with four display surfaces according to an embodiment of the present invention.

### DETAILED DESCRIPTION OF THE EMBODIMENTS

The specific implementations will be described in more details in conjunction with the accompanying drawings and the embodiments of the present invention. The following embodiments are used for illustrating the present invention, but not intended to limit the scope of the present invention.

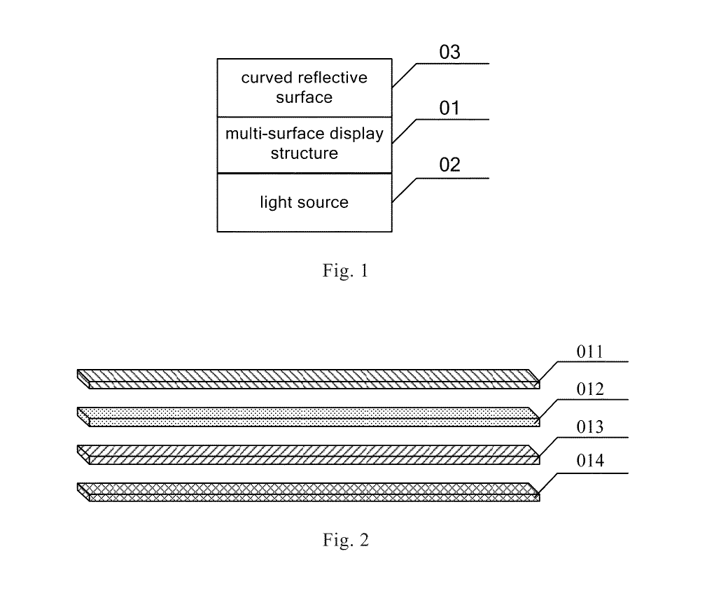

As shown in FIG. 1, the present invention provides a display device with multiple display surfaces, including: a multi-surface display structure 01 including at least two display panels; a light source 02 provided under the middle part of the display structure 01; and a curved reflective surface 03 is provided on the top of the multi-surface display structure 01. The curved reflective surface 03 includes at least two reflectors having inclination angles. The curved reflective surface 03 is used to reflect the light emitted from the light source 02 to the display surface of each display panel.

The light source is provided under the multi-surface display structure, such that the bottom space of the display device is efficiently utilized. In addition, circuit boards with respective functions in the display device may also be provided under the multi-surface display structure to facilitate the circuit control. The power supply of the circuit boards and the light source are both provided under the multi-surface display structure to prevent the power supply wirings from being complicated.

Further, the curved reflective surface 03 is configured by a plurality of reflectors having inclination angles, and the specific inclination angles are adjusted based on the number of the display panels and the positional relationship between the light source and the display panels. The curved reflective surface 03 is provided on the top of the multi-surface display structure 01, and may reflect the light emitted from the light source 02 to each display surface, such that the light source is efficiently used, and the efficiency of the light source is improved, while the uniformity of light on each display surface is ensured.

Further, in the present embodiment, as shown in FIG. 2, the display device with multiple display surfaces further includes an optical film 013 and a diffusion plate 014 successively stacked under the display panel 011. When the display device with multiple display surfaces is configured by a plurality of display panels, the display panel 011 is provided at the outermost sides of the display device with multiple display surfaces and the diffusion plate is provided at the innermost sides of the display device with multiple display surfaces. It is easy to understand that the directional term “under” indicates a positional relationship in FIG. 2.

It should be noted that the transmittance of the diffusion plate is adjusted according to the light intensity distribution of the light source. The transmittance of a part of the diffusion plate corresponding to strong light intensity is small, and the transmittance of a part of the diffusion plate corresponding to weak light intensity is large. The light intensity distribution represents the light intensity in each of directions of space. In the present embodiment, the transmittance of the diffusion plate is adjusted according to the light intensity distribution, such that a more uniform brightness on the display panel may be realized. The transmittance of the diffusion plate is controlled by a grid formed on its surface.

Further, the diffusion plate is a printing diffusion plate having reflective ink on its surface. A grid is formed on the printing diffusion plate, and the transmittance of the diffusion plate depends on the distribution of the grid.

It should be noted that, the display panel 011 in the present embodiment includes an upper polarizer and a lower polarizer (not shown in the Figures), and a supplementary polarizer 012 as a reflective polarizer is provided between the lower polarizer and the optical film 013. The transmitting axis of the supplementary polarizer is the same as that of the lower polarizer. Specifically, a supplementary polarizer 012, an optical film 013 such as a diffusion film or a BEF (brightness enhancement film) and a diffusion plate 014 are stacked in sequence behind the display panel. A conventional diffusion plate can sufficiently scatter the incident light and thus achieving a soft and uniform illuminating performance. In addition, according to the embodiment of the present invention, the transmittance of the diffusion plate is designed based on the light intensity distribution of the light source, such that the light transmitted through the diffusion plate are more uniform.

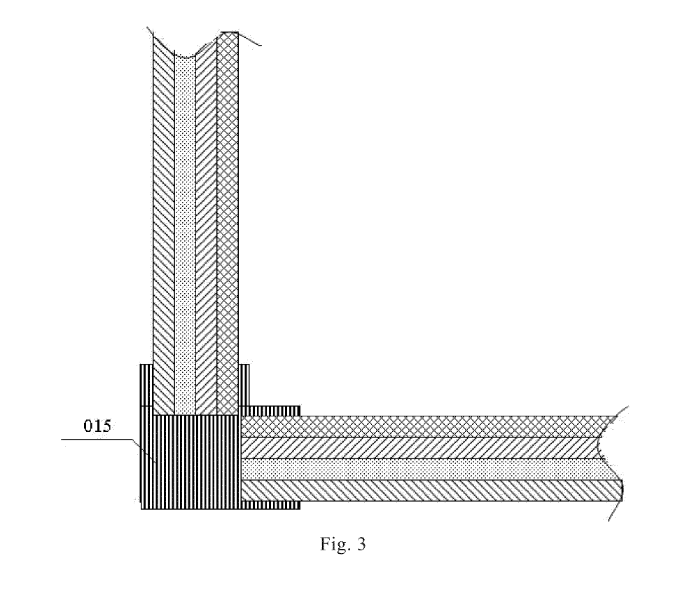

Further, a fixing structure 015 is used to connect and fix the different display panels in the present embodiment, as shown in FIG. 3. It should be noted that the fixing structure may be made of a metal material or a plastic material.

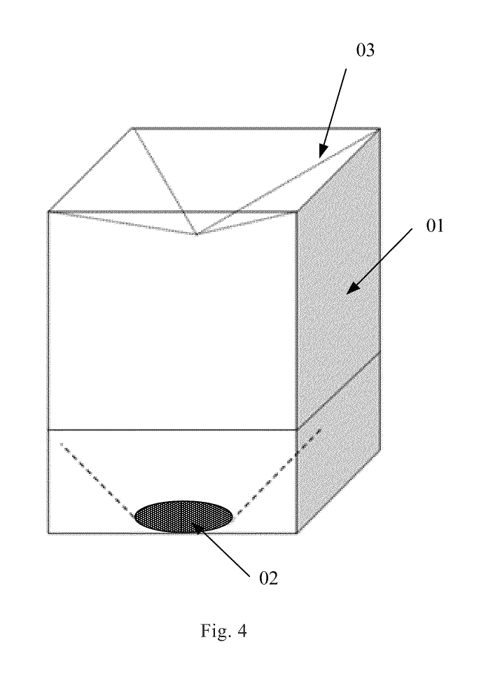

In the present embodiment, by taking a case that the number of the display panels is four as an example, as shown in FIG. 4, a display device with four display surfaces is configured by four display panels 100 (not particularly indicated in FIG. 4), and the display panels are arranged at the outermost sides while the diffusion plates are arranged at the innermost sides. The shape of a structure in which the other structures or film layers are arranged is annular. The light source provided under the middle part of the display structure is preferably a high brightness light source and the light emitting thereof is required to be uniform. The brightness of the light source is set based on the number and the size of the display panels during an actual design.

A curved reflective surface is provided on the top of the multi-surfaces display structure. Specifically, the curved reflective surface may be designed based on the number and the arrangement of the display panels. The curving reflective surface reflects the light emitted upward from the light source to the display surfaces at the side surfaces, so as to increase the utilization of the light energy. The distribution of the grid printed on the diffusion plate is adjusted according to the light intensity distribution of the light source, such that the uniformity of the light emergent from the display panel is ensured.

The above display device with four display surfaces may achieve the following beneficial effects, including:
(1) the requirement to the light source is low, so that a light source may be used in the present embodiment as long as the curves of light intensity distribution of individual light sources are not quite difference from each other.
(2) the total weight is low. A rear plate that is arranged behind the diffusion plate in a conventional display device has been removed since the display device with multiple display surfaces is formed by a plurality of display panels which are disposed at the outermost sides. Since the rear plate is a metal part, the removing of the rear plate may significantly lower the total weight of the display device.
(3) the light source is controlled consistently. Unlike the conventional controlling method in which each light source is controlled independently by a corresponding power supply, the present controlling method can adjust the color temperature under various environments, such that the color performance on the respective display panels are consistent with each other.
(4) a reflective polarizer is selected as the polarizer in the display panel, such that the light source is efficiently utilized. Therefore, the power consumption is reduced and the display performance is improved.
(5) the light source is provided at the bottom of the display device, so as to make a rational use of the bottom space of the display device, and other components such as circuit boards are provided at the bottom to facilitate the circuit control.

It should be noted that, the four-surface display described in the present embodiment is merely for the exemplary purpose, the present invention is not limited thereto. The present invention is suitable for any multi-surface (more than two surfaces) display, such as a three-surface display in which three display panels form a triangle structure, or a two-surface display in which two panels are parallel or form a certain angle therebetween. When the two panels form a certain angle therbetween, a supporting plate is disposed between the two display panels for supporting and fixing, so as to ensure that the structure is stable. Of course, the number of the surfaces in the multi-surface display may be more than four.

In the present embodiment, the light source is provided under the multi-surface display structure, so as to efficiently use the bottom space of the display device. The light shadow can be eliminated and thus improving the display performance. The curved reflective surface provided on the top of the multi-surface display structure can reflect the light emitted from the light source, so as to ensure that the light emergent from each display panel is uniform. Furthermore, the light energy is efficiently utilized (i.e., the utilization of the light source is increased), and thus the purpose of energy-saving is achieved.

It should be understood that, the above embodiments are merely exemplary embodiments for the purpose of explaining the principle of the present invention, and the present invention is not limited thereto. For a person skilled in the art, various improvements and modifications may be made to the present invention without departing from the spirit and essence of the present invention. These improvements and modifications are also deemed as the protection scope of the present invention.

What is claimed is:

1. A display device with multiple display surfaces, including: a multi-surface display structure including at least two display panels; a light source provided under the middle part of the display structure; and a curved reflective surface provided on the top of the multi-surface display structure; the curved reflective surface includes at least two reflectors having inclination angles, and the curved reflective surface is used to reflect the light emitted from the light source to the display surface of each display panel.

2. The display device with multiple display surfaces according to claim 1, wherein the inclination angles of the reflectors are adjusted based on the number of the display panels and the positional relationship between the light source and the display panels.

3. The display device with multiple display surfaces according to claim 1, wherein the display device with multiple display surfaces further includes an optical film and a diffusion plate stacked in sequence under each display panel, and the display panels are disposed at the outermost sides of the display device with multiple display surfaces and the diffusion plates are disposed at the innermost sides of the display device with multiple display surfaces.

4. The display device with multiple display surfaces according to claim 3, wherein the transmittance of the diffusion plate is adjusted according to the light intensity distribution of the light source, the transmittance of a part of the diffusion plate corresponding to a strong light intensity is small and the transmittance of a part of the diffusion plate corresponding to a weak light intensity is large.

5. The display device with multiple display surfaces according to claim 3, wherein the diffusion plate is a printing diffusion plate with reflective ink on its surface.

6. The display device with multiple display surfaces according to claim 3, wherein each display panel includes an upper polarizer and a lower polarizer, and a supplementary polarizer is arranged between the lower polarizer and the optical film, the transmitting axis of the supplementary polarizer is the same as that of the lower polarizer.

7. The display device with multiple display surfaces according to claim 6, wherein the supplementary polarizer is a reflective polarizer.

8. The display device with multiple display surfaces according to claim 1, wherein a fixing structure is used for connecting and fixing the display panels.

9. The display device with multiple display surfaces according to claim 8, wherein the fixing structure is made of a metal material or a plastic material.
